(19) United States
(12) Patent Application Publication
(10) Pub. No.: US 2025/0225010 A1
(43) Pub. Date: Jul. 10, 2025

(54) INFORMATION PROVIDING SYSTEM, ELECTRONIC APPARATUS, INFORMATION PROVIDING METHOD, AND NON-TRANSITORY RECORDING MEDIUM

(71) Applicant: Akiyoshi NAKAI, KANAGAWA (JP)

(72) Inventor: Akiyoshi NAKAI, KANAGAWA (JP)

(21) Appl. No.: 18/991,684

(22) Filed: Dec. 22, 2024

(30) Foreign Application Priority Data
Jan. 4, 2024 (JP) 2024-000156

(51) Int. Cl. G06F 11/00; G06F 11/32

(52) U.S. Cl. CPC G06F 11/004; G06F 11/327

(57) ABSTRACT

An information providing system includes circuitry and a display. The circuitry acquires data for determining a status of an electronic apparatus. The circuitry predicts an occurrence of a failure or an abnormality of the electronic apparatus based on the data. The circuitry determines a remedial action to be taken to avoid the failure or the abnormality of the electronic apparatus when the circuitry predicts the occurrence of the failure or the abnormality. The display displays the remedial action when the remedial action can be performed by a user.

### CROSS-REFERENCE TO RELATED APPLICATIONS

This patent application is based on and claims priority pursuant to 35 U.S.C. § 119(a) to Japanese Patent Application No. 2024-000156, filed on Jan. 4, 2024, in the Japan Patent Office, the entire disclosure of which is hereby incorporated by reference herein.

### BACKGROUND

### Technical Field

The present disclosure relates to an information providing system, an electronic apparatus, an information providing method, and a non-transitory recording medium.

### Related Art

In the related art, a predictive failure notification system determines whether a target electronic apparatus such as an image forming apparatus is in a predictive failure status based on the internal information of the target electronic apparatus.

### SUMMARY

According to an embodiment of the present disclosure, an information providing system includes circuitry and a display. The circuitry acquires data for determining a status of an electronic apparatus. The circuitry predicts an occurrence of a failure or an abnormality of the electronic apparatus based on the data. The circuitry determines a remedial action to be taken to avoid the failure or the abnormality of the electronic apparatus when the circuitry predicts the occurrence of the failure or the abnormality. The display displays the remedial action when the remedial action can be performed by a user.

According to one or more embodiments of the present disclosure, an electronic apparatus includes circuitry and a display. The circuitry acquires data for determining a status of the electronic apparatus. The circuitry predicts an occurrence of a failure or an abnormality of the electronic apparatus based on the data. The circuitry determines a remedial action to be taken avoid the failure or the abnormality of the electronic apparatus when the circuitry predicts the occurrence of the failure or the abnormality of the electronic apparatus. The display displays the remedial action when the remedial action can be performed by a user.

According to one or more embodiments of the present disclosure, an information providing method performed by one or more processors includes acquiring data for determining a status of an electronic apparatus. The information providing method includes predicting an occurrence of a failure or an abnormality of the electronic apparatus based on the data. The information providing method includes determining a remedial action to be taken to avoid the failure or the abnormality of the electronic apparatus when the occurrence of the failure or the abnormality of the electronic apparatus is predicted. The information providing method includes displaying the remedial action on a display when the remedial action can be performed by a user.

According to one or more embodiments of the present disclosure, a non-transitory recording medium storing a plurality of instructions which, when executed by one or more processors, causes the one or more processors to perform an information providing method. The information providing method includes acquiring data for determining a status of an electronic apparatus. The information providing method includes predicting an occurrence of a failure or an abnormality of the electronic apparatus based on the data. The information providing method includes determining a remedial action to be taken to avoid the failure or the abnormality of the electronic apparatus when the occurrence of the failure or the abnormality of the electronic apparatus is predicted. The information providing method includes displaying the remedial action on a display when the remedial action can be performed by a user.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a system configuration of an information providing system according to an embodiment;

FIG. 2 is a diagram illustrating an example of a system configuration of an information providing system according to an embodiment;

FIG. 3 is a block diagram illustrating an example of a hardware configuration of a computer according to an embodiment;

FIG. 4 is a block diagram illustrating an example of a hardware configuration of an image forming apparatus according to an embodiment;

FIG. 5 is a block diagram illustrating an example of a functional configuration of an information providing system according to an embodiment;

FIG. 6 is a flowchart illustrating an example of information-providing processing according to a first embodiment;

FIG. 7 is a diagram for describing an example of prediction processing according to the first embodiment;

FIG. 8 is a diagram illustrating an example of remedial action information according to the first embodiment;

FIG. 9 is a diagram illustrating an example of a display screen displayed by an image forming apparatus according to the first embodiment;

FIG. 10 is a diagram illustrating an example of a display screen displayed by an information terminal according to the first embodiment;

FIG. 11 is a flowchart illustrating an example of information-providing processing according to a second embodiment;

FIG. 12 is a diagram for describing an example of data processing according to the second embodiment;

FIG. 13 is a diagram for describing an example of the data processing according to the second embodiment;

FIG. 14 is a diagram for describing an example of the data processing according to the second embodiment;

FIG. 15 is a flowchart illustrating an example of display-control processing according to a third embodiment;

FIG. 16 is a flowchart illustrating an example of the display-control processing according to the third embodiment;

FIG. 17 is a flowchart illustrating an example of the display-control processing according to the third embodiment;

FIG. 18 is a flowchart illustrating an example of an information-providing processing according to a fourth embodiment;

FIG. 19 is a diagram illustrating an example of status transition of the information providing system according to the fourth embodiment; and

FIG. 20 is a block diagram illustrating another example of a functional configuration of an information providing system according to an embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given of several embodiments of the present disclosure with reference to drawings.

### System Configuration

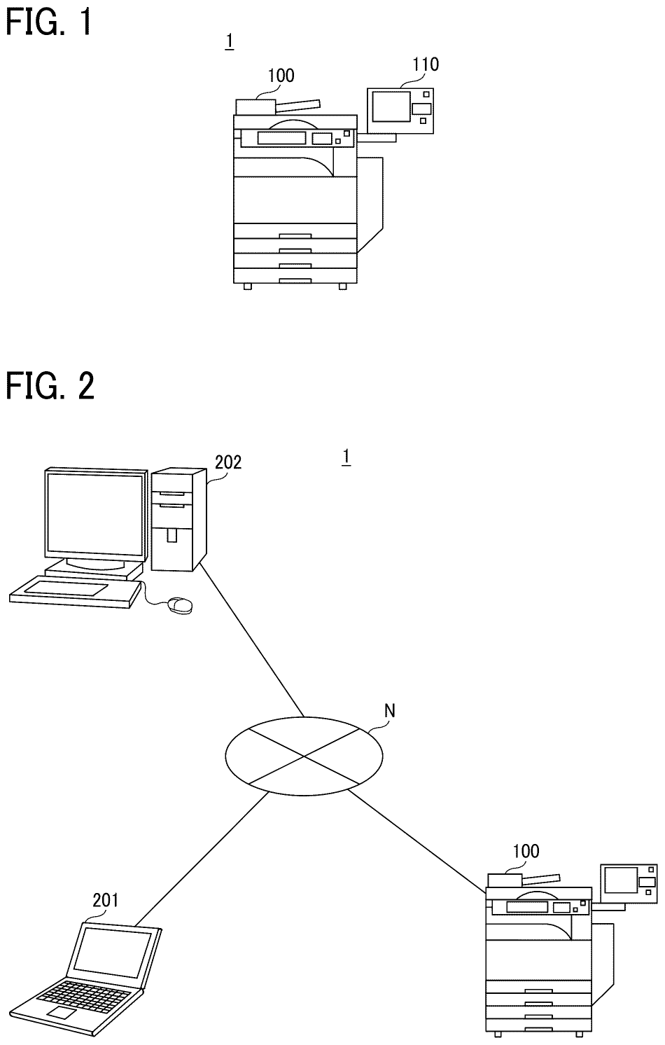

FIG. 1 and FIG. 2 are diagrams illustrating examples of a system configuration of an information providing system according to an embodiment.

FIG. 1 illustrates an example of the system configuration of the information providing system 1. In the example illustrated in FIG. 1, the information providing system 1 includes an image forming apparatus 100 having a control panel 110.

Examples of the image forming apparatus 100 (electronic apparatus) include an electronic apparatus such as a multi-function peripheral printer (MFP) having functions of a printer, a scanner, a copier, and a facsimile. The electronic apparatus according to the present embodiment is not limited to the MFP. Examples of the electronic apparatus may include a printer, a scanner, a copier, a projector, and an interactive whiteboard (IWB), which is a whiteboard having an electronic-blackboard function capable of intercommunicating with extraneous devices. In the following description, it is assumed that the image forming apparatus 100 (electronic apparatus) is the MFP.

The information providing system 1 determines a remedial action to be taken to avoid the occurrence of a failure or an abnormality when the occurrence of the failure or the abnormality is predicted in the image forming apparatus 100. The information providing system 1 displays the determined remedial action when a user can perform the determined remedial action.

For example, in the related art, when an image forming apparatus is in the predictive failure status, the magnitude of the failure risk of the image forming apparatus is determined and the determination result is notified. However, in the method according to the related art, since the determination result is information which prompts a user to arrange for a maintenance company, a failure may occur before the maintenance company arrives, and the downtime in which the image forming apparatus is not available may occur. In the present disclosure, a time period during which an apparatus is unavailable due to some problem is referred to as a “downtime.”

When the occurrence of a failure or an abnormality is predicted in the image forming apparatus 100, the information providing system 1 according to the present embodiment displays a remedial action that the user can perform among remedial actions to be taken to avoid the occurrence of a failure or an abnormality.

In the example illustrated in FIG. 1, the image forming apparatus 100 performs, for example, prediction processing of predicting the occurrence of a failure or an abnormality, determination processing of determining a remedial action to be taken to avoid the occurrence of a failure or an abnormality, and display processing of displaying a remedial action that the user can perform on the control panel 110.

Therefore, the information providing system 1 provides the user with a remedial action that the user can perform so that the user performs an action that the user can perform. Accordingly, the information providing system 1 improves the status of the image forming apparatus 100 according to the user's operation, and reduces the occurrence of downtime in which the image forming apparatus 100 is unavailable.

FIG. 2 is a block diagram illustrating another example of a system configuration of the information providing system 1. In the example illustrated in FIG. 2, the information providing system 1 includes an information terminal 201 and a server apparatus 202 that communicate with the image forming apparatus 100 via a communication network N.

Examples of the information terminal 201 include an information processing apparatus such as a personal computer (PC), a tablet terminal, or a smartphone used by the user. The user checks the status of the image forming apparatus 100 by using, for example, a web browser included in the information terminal 201, or an application program (hereinafter, referred to as an application) for the information providing system 1. When the occurrence of a failure or an abnormality in the image forming apparatus 100 is predicted, the information providing system 1 may display a remedial action that the user can perform on the information terminal 201.

The server apparatus 202 is an information processing apparatus having a configuration of a computer or a system including multiple computers. In the example illustrated in FIG. 2, a part of the processes performed by the image forming apparatus 100 in the information providing system 1 may be performed by the server apparatus 202. The server apparatus 202 performs, for example, the prediction processing of predicting the occurrence of a failure or an abnormality in the image forming apparatus 100, or the determination processing of determining a remedial action to be taken to avoid the occurrence of a failure or an abnormality. Consequently, the load on the image forming apparatus 100 is reduced.

### Hardware Configuration

### Hardware Configuration of Information Terminal and Server Apparatus

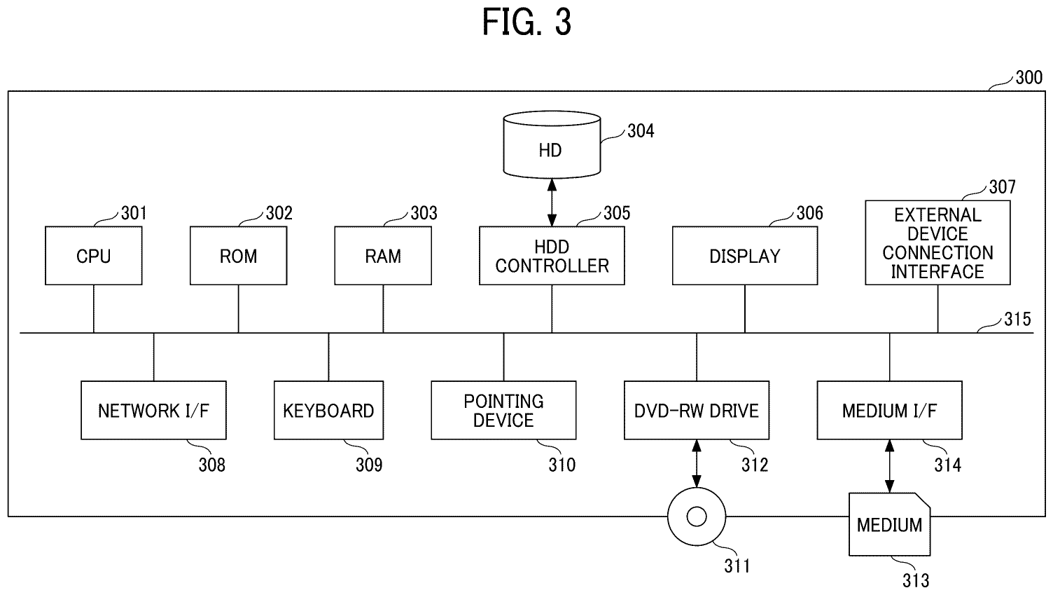

The information terminal 201 and the server apparatus 202 have, for example, a hardware configuration of a computer 300 as illustrated in FIG. 3. Alternatively, the server apparatus 202 may be implemented by multiple computers 300.

FIG. 3 is a block diagram illustrating an example of a hardware configuration of the computer 300. As illustrated in FIG. 3, the computer 300 includes, for example, a central processing unit (CPU) 301, a read-only memory (ROM) 302, a random-access memory (RAM) 303, a hard disk (HD) 304, a hard disk drive (HDD) controller 305, a display 306, an external device connection interface (I/F) 307, a network I/F 308, a keyboard 309, a pointing device 310, a digital versatile disc-rewritable (DVD-RW) drive 312, a medium I/F 314, and a bus line 315.

The CPU 301 controls the overall operation of the computer 300. The ROM 302 stores a program used for starting the computer 300, such as an initial program loader (IPL). The RAM 303 is used as a work area for the CPU 301, for example. The HD 304 stores, for example, programs including an operating system (OS), an application, and a printer driver, and various data. The HDD controller 305 controls reading or writing of various kinds of data from or to the HD 304 under the control of the CPU 301, for example.

The display 306 displays various information such as a cursor, menu, window, character, and image. The external device connection I/F 307 is an interface for connecting various external devices to the computer 300. The network I/F 308 is an interface that connects the computer 300 to the communication network N. The keyboard 309 is one example of an input device provided with keys for allowing the user to input characters, numerals, or various instructions. The pointing device 310 is another example of the input device, which allows the user to select or execute a specific instruction, select a target for processing, or move a cursor being displayed.

The DVD-RW drive 312 reads and writes various data from and to a DVD-RW 311, which is an example of a removable recording medium. The DVD-RW 311 is not limited to the DVD-RW, and other removable recording media may be used as the DVD-RW 311. The medium I/F 314 controls reading or writing (storing) of data from or to a medium 313 such as a flash memory. The bus line 315 includes an address bus and a data bus. The bus line 315 electrically connects the above-described components to each other and transmits various control signals.

### Hardware Configuration of Image Forming Apparatus

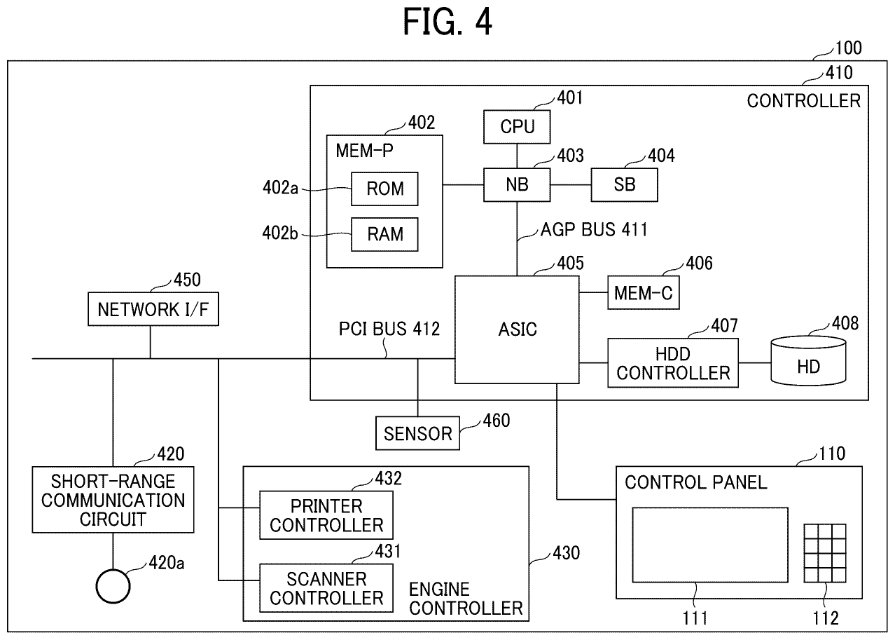

FIG. 4 is a block diagram illustrating an example of a hardware configuration of the image forming apparatus 100. As illustrated in FIG. 4, the image forming apparatus 100 includes a controller 410, a short-range communication circuit 420, an engine controller 430, the control panel 110, a network I/F 450, and one or more sensors 460.

The controller 410 includes a CPU 401 as a main processor, a system memory (MEM-P) 402, a north bridge (NB) 403, a south bridge (SB) 404, an application specific integrated circuit (ASIC) 405, a local memory (MEM-C) 406, an HDD controller 407, and an HD 408. The NB 403 and the ASIC 405 are connected to each other via an accelerated graphics port (AGP) bus 411.

The CPU 401 is a controller that controls overall operation of the image forming apparatus 100. The NB 403 connects the CPU 401 to the MEM-P 402, the SB 404, and the AGP bus 411. The NB 403 includes a memory controller that controls reading or writing of various data from or to the MEM-P 402, a peripheral component interconnect (PCI) master, and an AGP target.

The MEM-P 402 includes a ROM 402a as a memory that stores programs and data for implementing various functions of the controller 410. The MEM-P 402 further includes a RAM 402b as a memory that deploys the programs and data, or as a drawing memory that stores drawing data for printing. The programs stored in the RAM 402b may be stored in any computer-readable recording medium, such as a compact disc-read-only memory (CD-ROM), compact disc-recordable (CD-R), or digital versatile disc (DVD), in an installable or executable file format for distribution.

The SB 404 is a bridge that connects the NB 403 to PCI devices and peripheral devices. The ASIC 405 is an integrated circuit (IC) dedicated to an image processing use, and connects the AGP bus 411, a PCI bus 412, the HDD controller 407, and the MEM-C 406. The ASIC 405 includes a PCI target, an AGP master, an arbiter (ARB) as a central processor of the ASIC 405, a memory controller that controls the MEM-C 406, direct memory access controllers (DMACs) that convert coordinates of image data with a hardware logic, and a PCI unit that transfers data between a scanner controller 431 and a printer controller 432 through the PCI bus 412. The ASIC 405 may be connected to a universal serial bus (USB) interface or an Institute of Electrical and Electronics Engineers (IEEE) 1394 interface.

The MEM-C 406 is a local memory used as a buffer for image data to be copied or a code buffer. The HD 408 is a storage for storing image data, font data used in printing, and forms. The HDD controller 407 controls reading and writing of various data from and to the HD 408 under control of the CPU 401. The AGP bus 411 is a bus interface for a graphics accelerator card, which has been proposed to accelerate graphics processing. Through directly accessing the MEM-P 402 with high throughput, the AGP bus 411 increases the speed of the graphics accelerator card.

The short-range communication circuit 420 performs various short-range wireless communication using an antenna 420a or the like for the short-range communication circuit. The engine controller 430 includes, for example, the scanner controller 431 and the printer controller 432. The scanner controller 431 is a reading device that scans a document. The printer controller 432 is a printing device that performs printing based on print data. The scanner controller 431 and the printer controller 432 each perform image processing, such as error diffusion or gamma conversion.

The control panel 110 includes a panel display 111 and an operation panel 112. The panel display 111 is implemented by, for example, a touch panel that displays current settings or a selection screen to receive a user input. The operation panel 112 includes a numeric keypad that receives set values of various image forming parameters such as image density parameter and a start key that receives an instruction for starting copying. The controller 410 controls the overall operation of the image forming apparatus 100. For example, the controller 410 controls drawing, communication, or inputs from the control panel 110.

The network I/F 450 is an interface for performing data transmission using a network. The sensor 460 is a sensor disposed in each unit of the image forming apparatus 100. For example, the sensor 460 includes a first sensor and a second sensor, which will be described later. The short-range communication circuit 420, the network I/F 450, and the sensor 460 are electrically connected to the ASIC 405 through, for example, the PCI bus 412.

### Functional Configuration

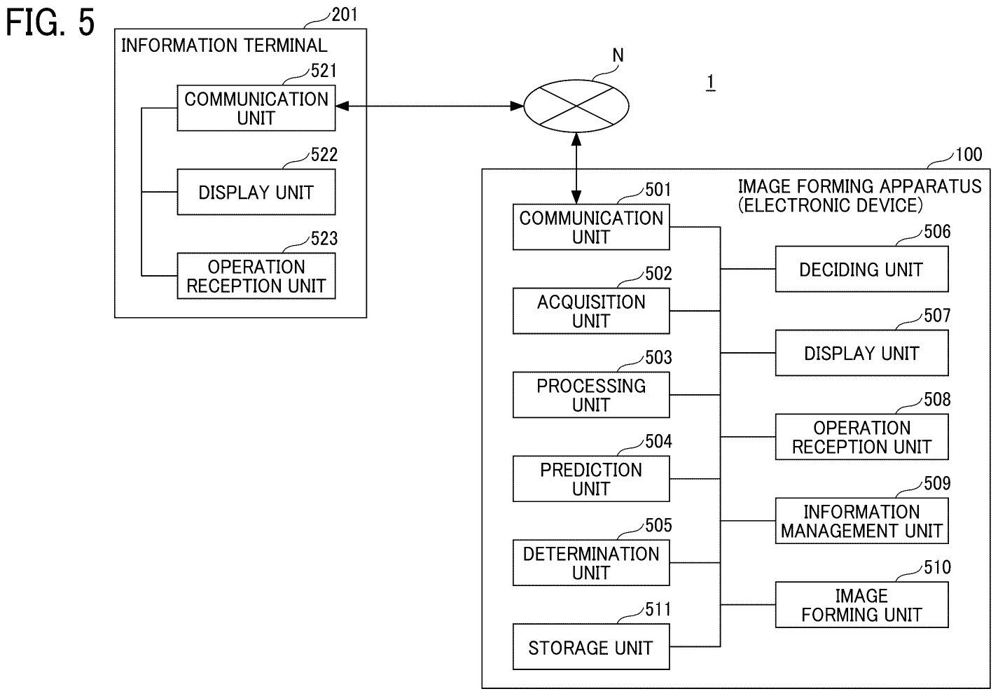

FIG. 5 is a block diagram illustrating an example of a functional configuration of the information providing system 1.

### Functional Configuration of Image Forming Apparatus

Each of the functional units of the image forming apparatus 100 (electronic apparatus) illustrated in FIG. 5 is implemented by the CPU 401 executing a predetermined program, for example. In the example illustrated in FIG. 5, the image forming apparatus 100 has the functional units such as a communication unit 501, an acquisition unit 502, a processing unit 503, a prediction unit 504, a determination unit 505, a deciding unit 506, a display unit 507, an operation reception unit 508, an information management unit 509, and an image forming unit 510. At least a part of the functional units may be implemented by hardware.

The image forming apparatus 100 further includes a storage unit 511 implemented by storage devices such as the HD 408 and the HDD controller 407.

The communication unit 501 connects the image forming apparatus 100 to the communication network N using, for example, the network I/F 450, and performs communication processing of communicating with other apparatuses such as the information terminal 201 or the server apparatus 202.

The acquisition unit 502 performs acquisition processing for acquiring data for determining the status of the image forming apparatus 100 (electronic apparatus). For example, the acquisition unit 502 may acquire sensor data from the sensor 460 as data for determining the status of the image forming apparatus 100. Alternatively, the acquisition unit 502 may acquire, for example, error log data output by the image forming unit 510, which will be described later, as data for determining the status of the image forming apparatus 100.

The processing unit 503 performs data processing of processing the data acquired by the acquisition unit 502 so that prediction accuracy by the prediction unit 504 to be described later increases. An example of the data processing performed by the processing unit 503 will be described later. The processing unit 503 in the image forming apparatus 100 is optional and can be omitted.

The prediction unit 504 performs the prediction processing of predicting a failure or an abnormality of the image forming apparatus 100 based on the data acquired by the acquisition unit 502. The prediction unit 504 may predict a failure or an abnormality of the image forming apparatus 100 using the data acquired by the acquisition unit 502. The prediction unit 504 may predict a failure or an abnormality of the image forming apparatus 100 using the data obtained by the processing unit 503 processing the data acquired by the acquisition unit 502. A detailed description is given below of an example of the prediction processing performed by the prediction unit 504.

When the prediction unit 504 predicts a failure or an abnormality of the image forming apparatus 100, the determination unit 505 performs determination processing of determining a remedial action to be taken to avoid the occurrence of a failure or an abnormality (a remedial action to be taken to improve the status of the image forming apparatus 100).

The deciding unit 506 performs processing of deciding whether the user can perform the remedial action determined by the determination unit 505.

When the user can perform the remedial action determined by the determination unit 505, the display unit 507 performs the display processing of displaying the remedial action on, for example, the control panel 110. The operation reception unit 508 performs operation-reception processing of receiving an operation by the user. For example, the operation reception unit 508 receives an operation by the user on the display screen displayed by the display unit 507.

The information management unit 509 performs information management processing of managing remedial action information including, for example, a remedial action corresponding to a failure or an abnormality predicted by the prediction unit 504 and information indicating whether the user can perform the remedial action. The information management unit 509 may store and manage the remedial action information in, for example, the storage unit 511, or may store and manage the remedial action information in an external-storage unit such as a storage server.

The image forming unit 510 controls image-forming processing such as printing processing, scanning processing, or copying processing, using, for example, the engine controller 430 and the sensor 460. For example, when an error such as a paper jam occurs, the image forming unit 510 stores error log data in, for example, the storage unit 511.

The storage unit 511 stores various data and information including the remedial action information managed by the information management unit 509 and the error log data output by the image forming unit 510.

### Functional Configuration of Information Terminal

Each of the functional units of the information terminal 201 illustrated in FIG. 5 is implemented by the CPU 301 executing a predetermined program, for example. In the example illustrated in FIG. 5, the information terminal 201 has the functional units such as a communication unit 521, a display unit 522, and an operation reception unit 523.

The communication unit 521 connects the information terminal 201 to the communication network N using, for example, the network I/F 308, and performs communication processing of communicating with other devices such as the image forming apparatus 100.

The display unit 522 performs, for example, display processing of displaying a remedial action which is determined by the image forming apparatus 100 and which the user can perform to avoid the occurrence of a failure or an abnormality of the image forming apparatus 100. It suffices that the information providing system 1 includes either the display unit 507 of the image forming apparatus 100 or the display unit 522 of the information terminal 201.

The operation reception unit 523 performs operation-reception processing of receiving an operation by the user. For example, the operation reception unit 523 receives an operation by the user on the display screen displayed by the display unit 522.

The functional configuration of the information providing system 1 illustrated in FIG. 5 is an example. For example, the information providing system 1 may not include the information terminal 201. In addition, at least a part of the functional units of the image forming apparatus 100 illustrated in FIG. 5 may be included in the server apparatus 202.

### Flow of Processing

A description is now given of a flow of an information providing method.

### First Embodiment

### Information-Providing Processing

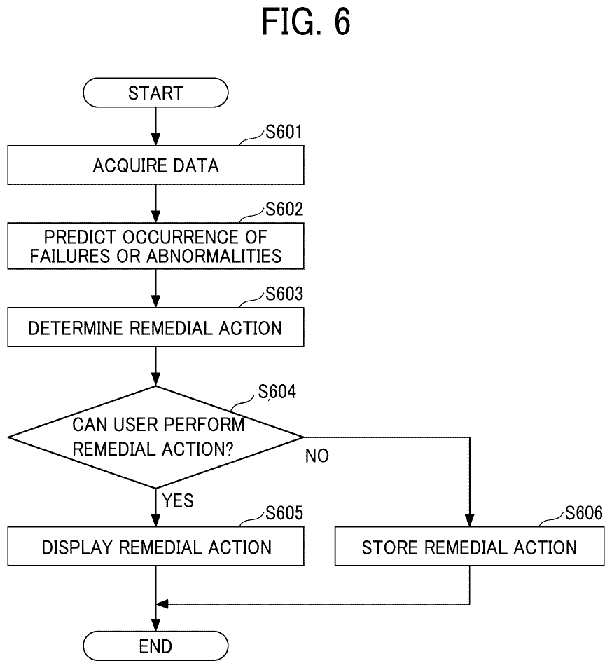

FIG. 6 is a flowchart illustrating an example of information-providing processing according to the first embodiment. This process is an example of the information-providing processing performed by the information providing system 1 illustrated in FIG. 5.

In step S601, the acquisition unit 502 acquires data for determining the status of the image forming apparatus 100.

In step S602, the image forming apparatus 100 predicts the occurrence of a failure or an abnormality based on the data acquired by the acquisition unit 502.

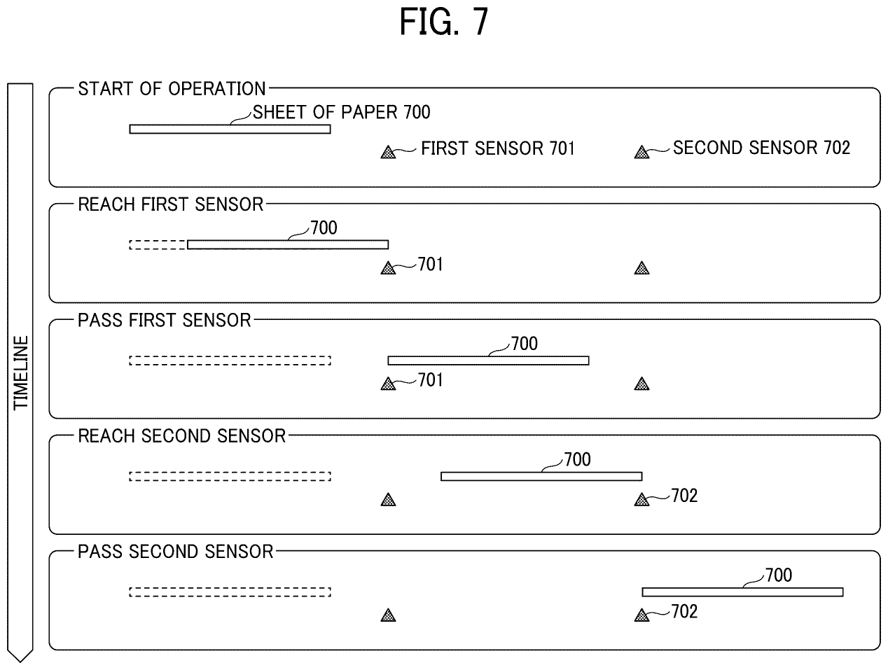

FIG. 7 is a diagram for describing an example of the prediction processing according to the first embodiment. There are various factors for a paper jam (referred to simply as a “jam” in the following description) in the image forming apparatus 100. A description is now given of a case where the occurrence of a jam caused by a temporal change of the image forming apparatus 100 is predicted.

As indicated in START OF OPERATION of FIG. 7, when an operation is started, a sheet 700 starts to move toward a first sensor 701. As indicated in REACH FIRST SENSOR of FIG. 7, the sheet 700 reaches the first sensor 701. As indicated in PASS FIRST SENSOR of FIG. 7, the sheet 700 passes through the first sensor 701. As indicated in REACH SECOND SENSOR of FIG. 7, the sheet 700 reaches a second sensor 702. As indicated in PASS SECOND SENSOR of FIG. 7, the sheet 700 passes through the second sensor 702.

At this time, the acquisition unit 502 may acquire the following data A to D as an example.

The data A is a first required time, which is a time required for the sheet 700 to reach the first sensor 701.

The data B is a second required time, which is a time required for the sheet 700 to pass through the first sensor 701.

The data C is a third required time, which is a time required for the sheet 700 to reach the second sensor 702.

The data D is a fourth required time, which is a time required for the sheet 700 to pass through the second sensor 702.

When the jam occurs due to a temporal change of the image forming apparatus 100, a change is observed in any one of the first to fourth required times. For example, when printing is started and the jam occurs due to a failure in feeding a sheet for some reason, the first required time is likely to be longer than a usual required time. In the case of the temporal change, these data do not change rapidly, but these data change little by little. Based on such a tendency, the prediction unit 504 predicts the occurrence of the jam.

The jam is an example of a failure or an abnormality of the image forming apparatus 100.

As the usual required time, for example, a representative value (e.g., an average time) of the past first required times stored in time series may be used, the first required time immediately after the remedial action was performed in the past may be used, or a predetermined time may be used.

As a prediction method, for example, the prediction unit 504 may calculate a difference between each of the first to fourth required times at the current time and the past required time, and predict that the jam will occur within a predetermined time when any one of the differences exceeds a threshold.

However, in this prediction method, there is a possibility that the prediction unit 504 predicts that the jam will occur even when the difference exceeds the threshold instantaneously (e.g., due to an accidental event such as an operation mistake). Therefore, the prediction unit 504 may calculate a weighted average with past data and compare the weighted average with the threshold, for example. Alternatively, the prediction unit 504 may generate an approximate curve (or a straight line) regarding data fluctuation using multiple latest data, and predict how many more sheets can be printed before the jam occurs.

Alternatively, the prediction unit 504 may calculate the first to fourth required times after a predetermined time elapses by a pre-trained machine learning model, such as recurrent neural networks (RNN) that predicts time-series data, based on past time-series data, and may compare each of the required times with a threshold. Furthermore, the prediction unit 504 may predict the occurrence of a failure or an abnormality in the image forming apparatus 100 by another machine learning model.

The threshold is not limited to a fixed value. For example, when the prediction unit 504 predicts how many more sheets can be printed before the jam occurs, the time required to print the predicted number of sheets varies based on the user's use status. In order to cope with such a case, the prediction unit 504 may adaptively change the threshold.

The occurrence of the jam is an example of the occurrence of a failure or an abnormality of the image forming apparatus 100 predicted by the prediction unit 504. The prediction unit 504 may predict the occurrence of another failure or another abnormality that occurs in the image forming apparatus 100. For example, the prediction unit 504 may predict the occurrence of a streak image such as a black streak that occurs in the copy processing. In this case, the prediction unit 504 may predict the occurrence of a streak image using sensor data output by the sensor 460 that detects dust on the contact glass of the image forming apparatus 100.

Referring again to FIG. 6, the description of the flowchart will be continued. In step S603, when the prediction unit 504 predicts a failure or an abnormality of the image forming apparatus 100, the determination unit 505 determines a remedial action to be taken to avoid the failure or the abnormality. The remedial actions to be taken to avoid a failure or an abnormality includes a method for improving the status of the image forming apparatus 100 related to the failure or the abnormality that is predicted to occur.

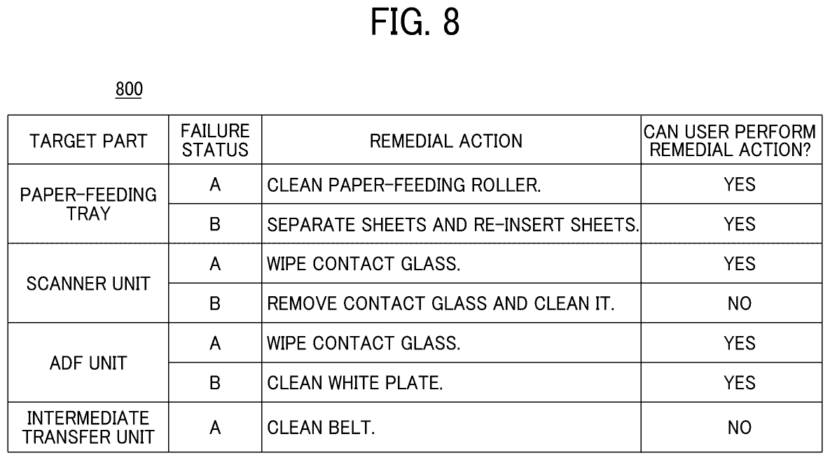

As an example, the determination unit 505 may determine a remedial action to avoid a failure or an abnormality using remedial action information 800 as illustrated in FIG. 8.

FIG. 8 is a diagram illustrating an example of the remedial action information according to the first embodiment. As an example, the information management unit 509 stores and manages remedial action information 800 as illustrated in FIG. 8 in, for example, the storage unit 511 or an external device.

In the example illustrated in FIG. 8, the remedial action information 800 includes information such as “target part,” “failure status,” “remedial action,” and “can user perform remedial action?” as items. The “target part” and the “failure status” are examples of information for identifying a failure or an abnormality that is predicted to occur. The information for identifying a failure or an abnormality that is predicted to occur may be, for example, a predetermined error code.

The “remedial action” is information indicating a remedial action corresponding to the “target part” and the “failure status.” For example, in the example illustrated in FIG. 8, the remedial action corresponding to the failure status “A” of the target part “paper-feeding tray” is “clean paper-feeding roller.” The “can user perform remedial action?” is information indicating whether the user can perform each of the remedial actions.

The determination unit 505 determines a remedial action to be taken to avoid a failure or an abnormality using, for example, the remedial action information 800. However, the present disclosure is not limited to this, and the determination unit 505 may determine a remedial action to be taken to avoid a failure or an abnormality based on, for example, a database storing multiple error codes and the remedial action corresponding to each of the multiple error codes.

Referring again to FIG. 6, the description of the flowchart will be further continued. In step S604, the deciding unit 506 decides whether the user can perform the remedial action determined by the determination unit 505. For example, the deciding unit 506 decides whether the user can perform the remedial action determined by the determination unit 505 based on the information of “user performance availability” of the remedial action information 800 as illustrated in FIG. 8. However, the present disclosure is not limited thereto, and the deciding unit 506 may decide whether the user can perform the remedial action determined by the determination unit 505 using, for example, a database storing multiple error codes and information indicating whether the user can perform the remedial action corresponding to each of the multiple error codes.

When the user can perform the remedial action determined by the determination unit 505, the deciding unit 506 proceeds the process to step S605. On the other hand, when the user cannot perform the remedial action determined by the determination unit 505, the deciding unit 506 proceeds the process to step S606.

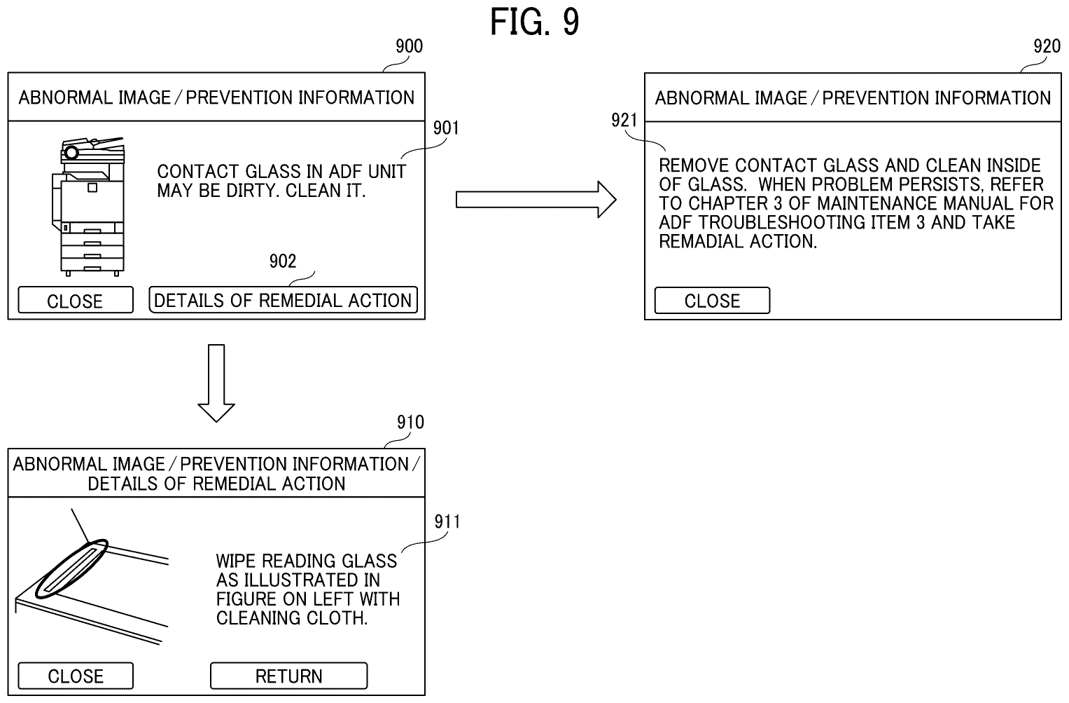

When the process proceeds to step S605, the display unit 507 displays the remedial action determined by the determination unit 505. For example, when the occurrence of an abnormal image is predicted in the image forming apparatus 100, the display unit 507 displays prevention information 900 as illustrated in FIG. 9 on, for example, the control panel 110 of the image forming apparatus 100.

FIG. 9 is a diagram illustrating an example of a display screen displayed by the image forming apparatus according to the first embodiment.

In the example illustrated in FIG. 9, information 901 for preventing an occurrence of an abnormal image is displayed in the prevention information 900. When the user selects a “DETAILS OF REMEDIAL ACTION” button 902 of the prevention information 900, the display unit 507 displays a details screen 910 for remedial action for the user on the control panel 110. The details screen 910 for remedial action for the user displays detailed information 911 of the remedial action that the user can perform.

On the other hand, for example, the maintenance person of the image forming apparatus 100 inputs, for example, a predetermined password to the control panel 110 when the prevention information 900 is displayed. According to such an operation by the maintenance person, a detailed screen 920 of the remedial action for the maintenance person is displayed. The detailed screen 920 of the remedial action for the maintenance person displays, for example, detailed information 921 of remedial action that cannot be performed or is difficult to be performed by the user.

In step S605 of FIG. 6, the display unit 522 of the information terminal 201 may display the remedial action determined by the determination unit 505, instead of (or in addition to) the display unit 507 of the image forming apparatus 100.

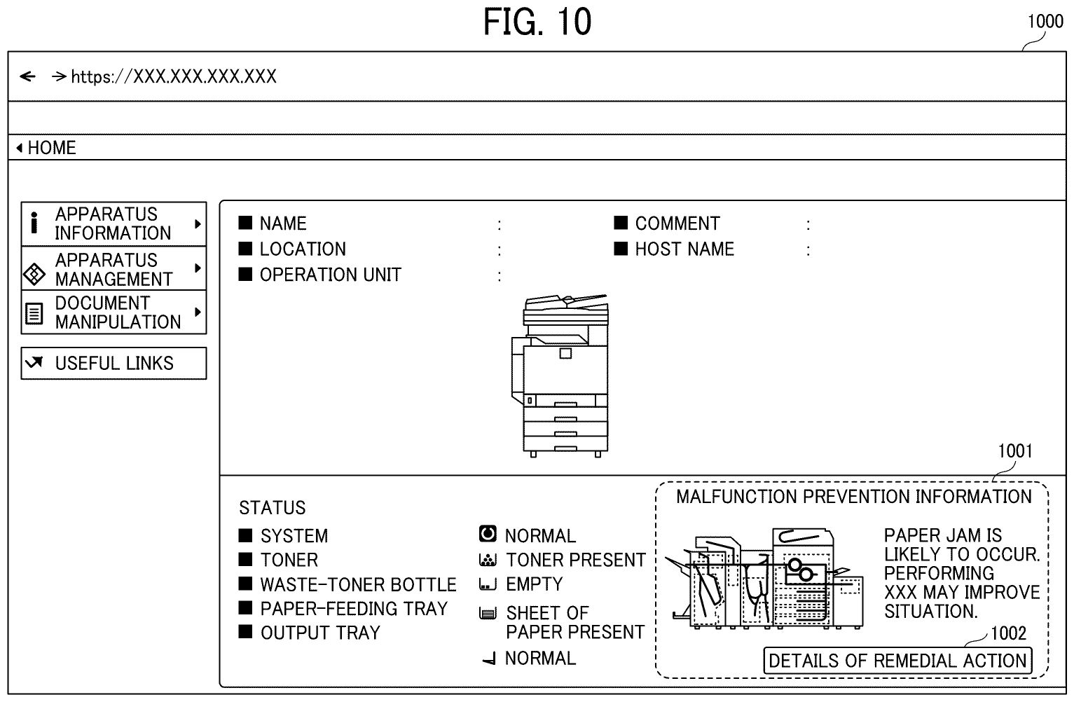

FIG. 10 is a diagram illustrating an example of a display screen displayed by the information terminal 201 according to the first embodiment. For example, in step S605 of FIG. 6, the display unit 522 of the information terminal 201 may display a display screen 1000 as illustrated in FIG. 10. In the example illustrated in FIG. 10, prevention information 1001 indicating the remedial action determined by the determination unit 505 is displayed on a part of the display screen 1000 displayed by the information terminal 201. Also in the display screen 1000, the user can display details of the remedial action by selecting a “DETAILS OF REMEDIAL ACTION” button 1002.

Referring again to FIG. 6, the description of the flowchart will be continued. When the process proceeds from step S604 to step S606, the information providing system 1 stores the remedial action in, for example, the storage unit 511 instead of displaying the remedial action determined by the determination unit 505.

By the process illustrated in FIG. 6, the information providing system 1 can provide the user with a remedial action that can be performed by the user so that the user can perform the remedial action that can be performed by the user. Accordingly, the information providing system 1 improves the status of the image forming apparatus 100 according to the user's operation, and reduces the occurrence of the downtime during which the image forming apparatus 100 is unavailable.

### Second Embodiment

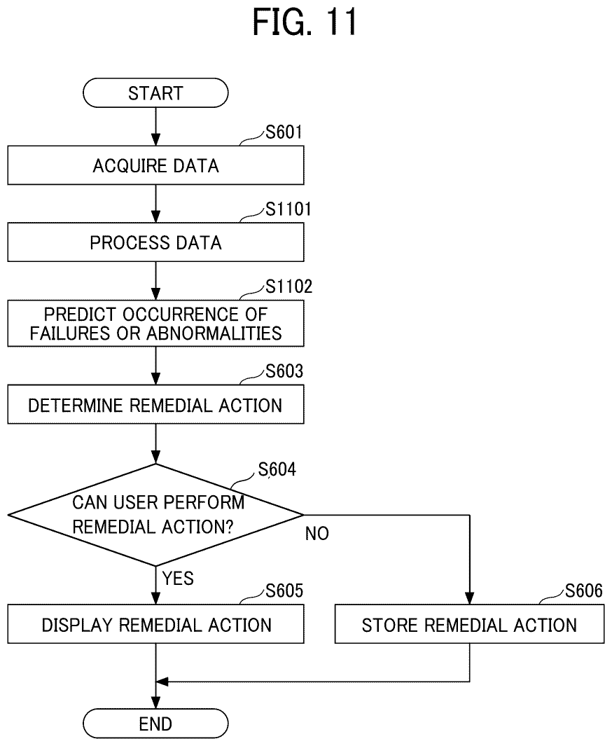

FIG. 11 is a flowchart illustrating an example of the information-providing processing according to a second embodiment.

In the process of FIG. 11, the processes of steps S601 and S603 to S606 are the same as the processes of the information providing system 1 according to the first embodiment described with reference to FIG. 6. Accordingly, the detailed description of the same processes as those of the first embodiment will be omitted below.

In step S1101, the processing unit 503 performs data processing of processing the data acquired by the acquisition unit 502 so that the prediction accuracy by the prediction unit 504 increases.

In step S1102, the prediction unit 504 predicts the occurrence of a failure or an abnormality in the image forming apparatus 100 using the data obtained by the processing unit 503.

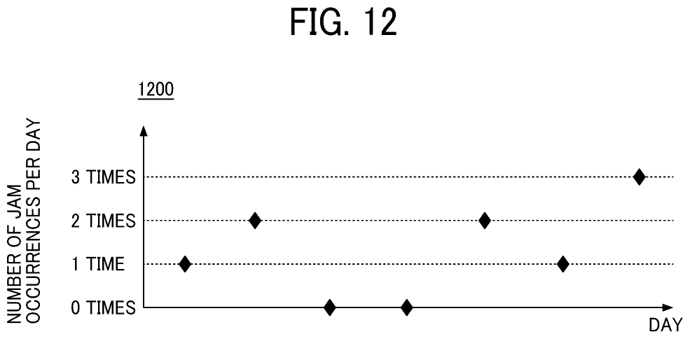

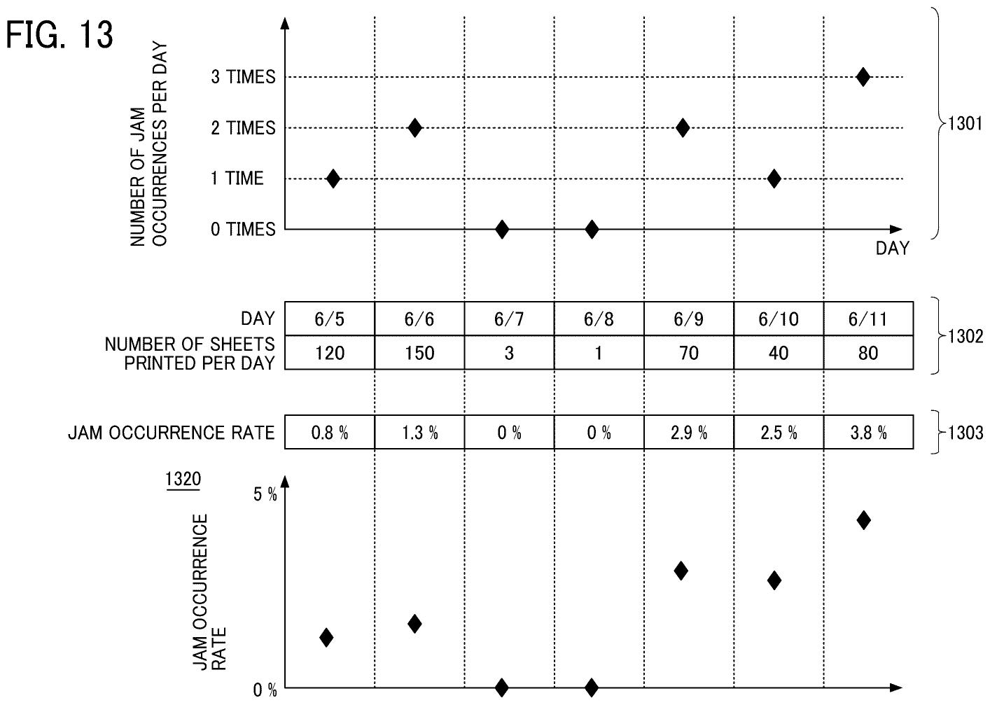

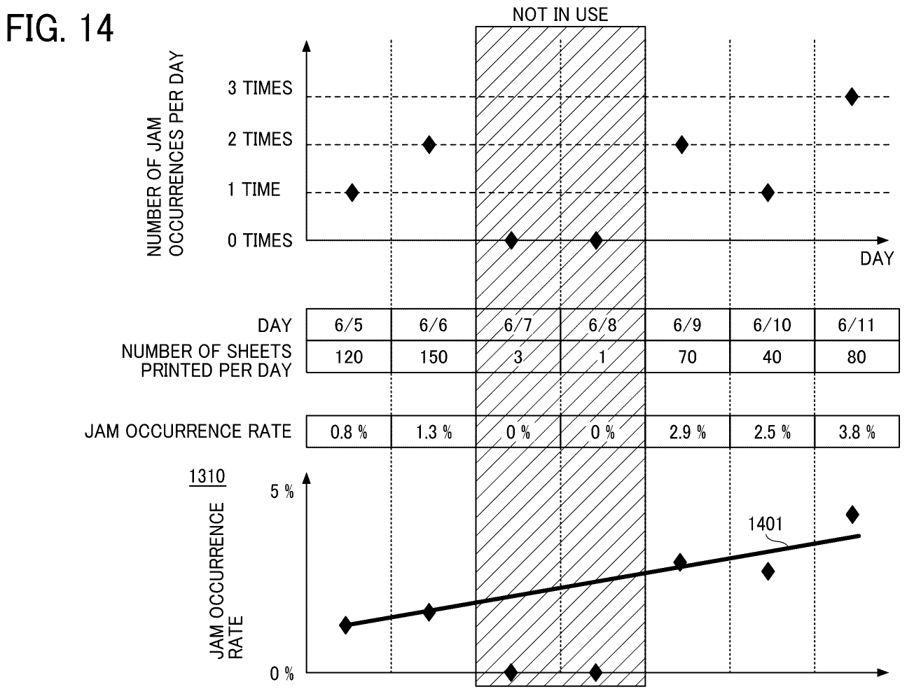

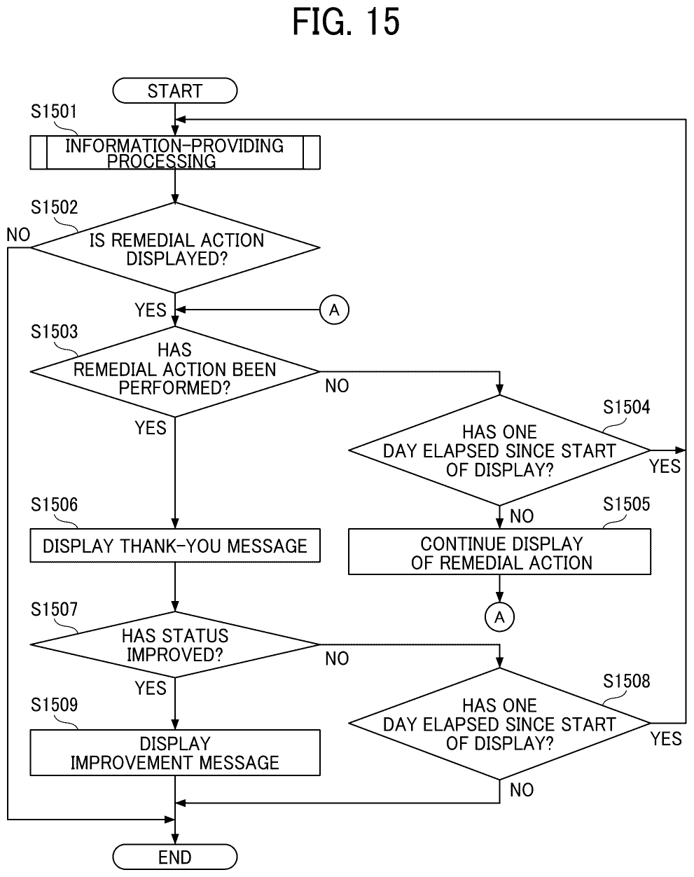

FIG. 12, FIG. 13, and FIG. 14 are diagrams for describing an example of the data processing according to the second embodiment. FIG. 12 is a graph 1200 of the number of times of occurrence of the jam in the image forming apparatus 100, with the horizontal axis representing the number of days and the vertical axis representing the number of times of occurrence of the jam per day. When the graph 1200 is viewed, the occurrence of the jam appears to be calm.

FIG. 13 is the number of times 1301 of occurrence of the jam per day, the number of sheets 1302 printed per day, and a graph 1320 of an occurrence rate 1303 of the jam calculated using the number of sheets 1302 printed per day as the population number.

When the graph 1320 is viewed, the graph 1200 which appears not to fluctuate much in FIG. 12 appears to have a slight upward tendency. However, in the graph 1320, when an approximate straight line of the occurrence rate 1303 of the jam is drawn, it cannot be recognized that the occurrence rate 1303 of the jam is clearly on the increase, due to the influence of the days (6/7 and 6/8) on which the number of sheets 1302 printed per day is extremely small.

FIG. 14 illustrates a graph 1310 in which the days (6/7 and 6/8) on which the number of sheets 1302 printed per day is extremely small in the graph 1320 of the occurrence rate of the jam are excluded as anomalous days, and an approximate straight line 1401 is drawn. In FIG. 14, it can be recognized that the occurrence rate of the jam steadily increases.

Regarding the anomalous day, in the case of the image forming apparatus 100, the usage amount tends to extremely decrease on, for example, holidays. Accordingly, the processing unit 503 may set holidays as anomalous days based on, for example, calendar information. However, since the holidays may be different depending on a user, the processing unit 503 may determine the anomalous day based on data, such as by excluding an extremely small value (e.g., a region of a lower limit of 5% of the overall average) from the overall data.

Accordingly, the processing unit 503 may enhance the prediction accuracy by the prediction unit 504 by excluding the data of the anomalous day from the data acquired by the acquisition unit 502. The prediction unit 504 may perform the data processing instead of the processing unit 503. The acquisition unit 502 may acquire data processed by, for example, an external device.

Accordingly, the information providing system 1 according to the second embodiment can enhance the prediction accuracy by the prediction unit 504 by the data processing performed by the processing unit 503.

### Third Embodiment

In the third embodiment, a description is now given of display-control processing performed by the information providing system 1.

### Display-Control Processing 1

FIG. 15 is a flowchart illustrating an example of display-control processing according to the third embodiment. This process is an example of display-control processing performed by the information providing system 1 after displaying the remedial action that the user can perform by the information-providing processing described with reference to, for example, FIG. 6 or FIG. 11.

In step S1501, the information providing system 1 performs the information-providing processing described with reference to, for example, FIG. 6 or 11.

In step S1502, the information providing system 1 determines whether a remedial action that the user can perform is displayed by the information-providing processing performed in step S1501. When the remedial action is not displayed, the information providing system 1 ends the process illustrated in FIG. 15. On the other hand, when the remedial action is displayed, the information providing system 1 proceeds the process to step S1503.

When the process proceeds to step S1503, the information providing system 1 determines whether the user has performed the displayed remedial action. As a method of determining whether the user has performed the displayed remedial action, for example, an operation button for inquiring whether the displayed remedial action has been performed may be displayed on the control panel 110, and whether the displayed remedial action has been performed may be determined based on an operation by the user.

When the user has not performed the remedial action, the information providing system 1 proceeds the process to step S1504. On the other hand, when the user has performed the remedial action, the information providing system 1 proceeds the process to step S1506.

When the process proceeds to step S1504, the information providing system 1 determines whether one day has elapsed from the start of display of the remedial action. One day is an example of a predetermined period, and any other period may be used. When one day has not elapsed from the start of display of the remedial action, the information providing system 1 proceeds the process to step S1505. On the other hand, when one day has elapsed from the start of display of the remedial action, the information providing system 1 returns the process to step S1501. Accordingly, when the user has not performed the remedial action, the information providing system 1 performs the prediction processing and updates the prediction result every day (every predetermined period).

When the process proceeds to step S1505, the information providing system 1 continues displaying the remedial action and returns the process to step S1503.

When the process proceeds from step S1503 to step S1506, the information providing system 1 displays a message of thanks for performing the remedial action. Accordingly, the information providing system 1 can enhance a motivation for the user to perform the remedial action. Additionally, in order to further enhance the motivation of the user, the information providing system 1 may display, for example, privilege information for giving a special reward to the user in addition to (or instead of) the message of thanks.

In step S1507, the information providing system 1 determines whether the status of the image forming apparatus 100 has improved. As a method of determining whether the status has improved, for example, in the example described with reference to FIG. 7, the information providing system 1 may determine that the status has improved when any one of the first to fourth required times has improved (i.e., when the required time is closer to the target value) after the remedial action is performed.

Depending on a failure or an abnormality that is predicted to occur, it may be difficult to determine whether the status has improved. In this case, the information providing system 1 may omit the process of steps S1507 to S1509 and end the process described with reference to FIG. 15.

When the process proceeds to step S1508, the information providing system 1 determines whether one day has elapsed from the start of display of the remedial action. One day is an example of a predetermined period. When one day has elapsed from the start of display of the remedial action, the information providing system 1 returns the process to step S1501. On the other hand, when one day has not elapsed from the start of display of the remedial action, the information providing system 1 ends the process illustrated in FIG. 15.

The process illustrated in FIG. 15 can prevent the prevention information 900 as illustrated in FIG. 9 from being frequently displayed when the status of the image forming apparatus 100 has not improved even if the user performs the remedial action.

### Display-Control Processing 2

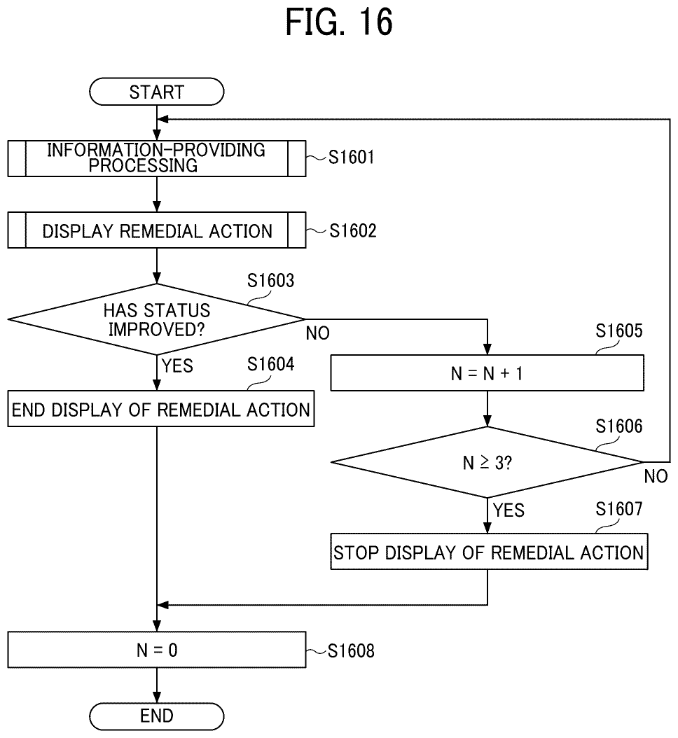

FIG. 16 is a flowchart illustrating another example of the display-control processing according to the third embodiment. This process is an example of display-control processing performed by the information providing system 1 after displaying the remedial action that the user can perform by the information-providing processing described with reference to, for example, FIG. 6 or 11.

For example, when the user performs the remedial action according to the prevention information 900 as illustrated in FIG. 9, a case that the remedial action is not appropriately performed is assumed. In such a case, the status of the image forming apparatus 100 continues to be in a bad state, and therefore, prompting the user to perform the remedial action is displayed many times, which may worsen the impression of the user.

In order to avoid such a situation, it is desirable that the information providing system 1 performs control so that the prevention information 900 is not displayed more than a predetermined number of times even if the remedial action is not appropriately performed by the user. In this case, the information providing system 1 may perform, for example, the display-control processing as illustrated in FIG. 16.

In step S1601, the information providing system 1 performs the information-providing processing described with reference to, for example, FIG. 6 or 11.

In step S1602, the information providing system 1 performs the display processing of displaying a remedial action as illustrated in, for example, steps S1502 to S1506 of FIG. 15.

In step S1603, the information providing system 1 determines whether the status of the image forming apparatus 100 has improved. When the status has improved, the information providing system 1 proceeds the process to step S1604. On the other hand, when the status has not improved, the information providing system 1 proceeds the process to step S1605.

When the process proceeds to step S1604, the information providing system 1 ends displaying the remedial action. As described above, the information providing system 1 may omit displaying the remedial action when the status has improved.

When the process proceeds to step S1605, the information providing system 1 increments a counter N by 1. In step S1606, the information providing system 1 determines whether the counter N is equal to or larger than a predetermined value “3.” The predetermined value “3” is an example, and may be any other value.

When the counter N is less than the predetermined value “3,” the information providing system 1 returns the process to step S1601. On the other hand, when the counter N is equal to or larger than the predetermined value “3,” the information providing system 1 proceeds the process to step S1607.

When the process proceeds to step S1607, the information providing system 1 stops displaying the remedial action.

When the process proceeds to step S1608, the information providing system 1 initializes the counter N to 0, and ends the process illustrated in FIG. 16.

By the process illustrated in FIG. 16, the information providing system 1 can perform control so that the prevention information 900 is not displayed more than the predetermined number of times even if the remedial action is not appropriately performed by the user.

### Display-Control Processing 3

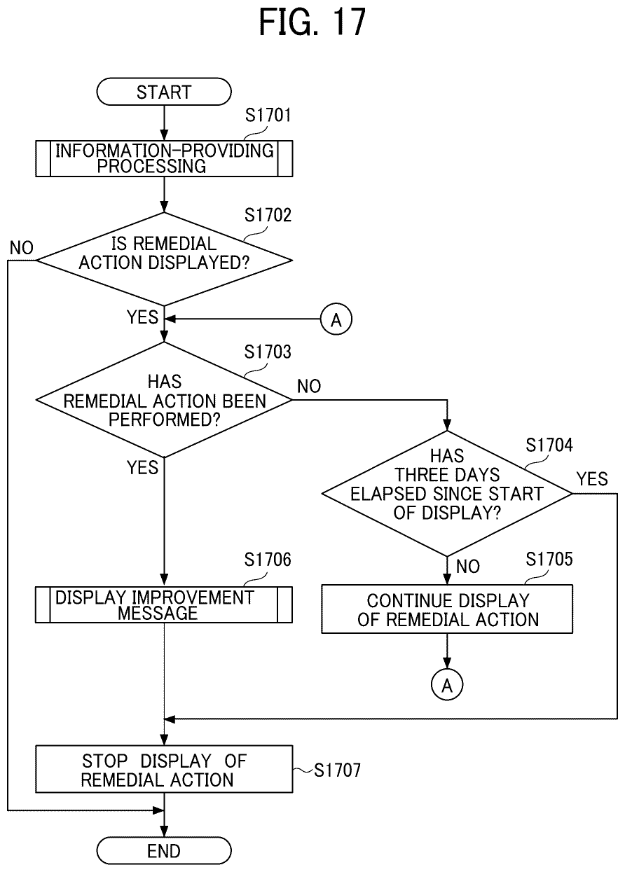

FIG. 17 is a flowchart illustrating still another example of the display-control processing according to the third embodiment. This process is an example of display-control processing performed by the information providing system 1 after displaying the remedial action that the user can perform by the information-providing processing described with reference to, for example, FIG. 6 or 11.

In the process described with reference to FIG. 15 or 16, it is assumed that the user performs the remedial action displayed as the prevention information 900 as illustrated in, for example, FIG. 9 in the information providing system 1. However, not all users may perform the remedial action. If the prevention information 900 is continuously displayed to such a user, the user may have a bad impression, for example, that the image forming apparatus 100 is always in a bad condition.

In order to avoid such a situation, it is desirable that the information providing system 1 stops displaying the prevention information 900 when a predetermined period has elapsed after the prevention information 900 is displayed. In this case, the information providing system 1 may perform the display-control processing as illustrated in, for example, FIG. 17.

In step S1701, the information providing system 1 performs the information-providing processing described with reference to, for example, FIG. 6 or 11.

In step S1702, the information providing system 1 determines whether a remedial action that the user can be perform is displayed by the information-providing processing performed in step S1701. When the remedial action is not displayed, the information providing system 1 ends the process illustrated in FIG. 15. On the other hand, when the remedial action is displayed, the information providing system 1 proceeds the process to step S1703.

When the process proceeds to step S1703, the information providing system 1 determines whether the user has performed the displayed remedial action. When the user has not performed the remedial action, the information providing system 1 proceeds the process to step S1704. On the other hand, when the user has performed the remedial action, the information providing system 1 proceeds the process to step S1706.

When the process proceeds to step S1704, the information providing system 1 determines whether three days or more have elapsed from the start of display of the remedial action. Three days is an example of a predetermined period, and any other period may be used. When three days or more have not elapsed from the start of display of the remedial action, the information providing system 1 proceeds the process to step S1705. On the other hand, when three days or more have elapsed from the start of display of the remedial action, the information providing system 1 proceeds the process to step S1707.

When the process proceeds from step S1703 to step S1706, the information providing system 1 performs the display processing of displaying an improvement message as illustrated in steps, for example, S1507 to S1509 of FIG. 15.

When the process proceeds to step S1707, the information providing system 1 ends displaying the remedial action. By the process illustrated in FIG. 17, the information providing system 1 can stop displaying the remedial action when a predetermined period has elapsed after the remedial action that the user can perform is displayed.

### Fourth Embodiment

In the fourth embodiment, a description is now given of processing in a case where the information providing system 1 arranges, for example, the maintenance person instead of displaying a remedial action when the user cannot perform the remedial action determined by the determination unit 505.

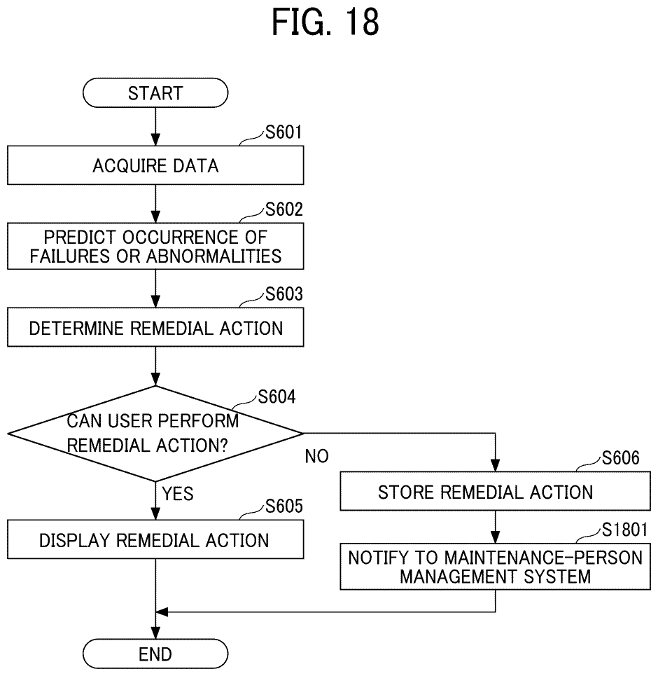

FIG. 18 is a flowchart illustrating an example of information-providing processing according to the fourth embodiment. In the process of FIG. 18, the processes of steps S601 to S606 are the same as the processes of the information-providing processing according to the first embodiment described with reference to FIG. 6. Accordingly, the detailed description of the same processes as those of the first embodiment will be omitted below.

In step S1801, the information providing system 1 notifies, for example, a maintenance person management system that arranges the maintenance person of, for example, information on the image forming apparatus 100 in which the prediction unit 504 predicts the occurrence of a failure or an abnormality, information on a remedial action that is determined by the determination unit 505 and that the user cannot perform.

The maintenance person management system is a system that, for example, arranges the maintenance person, and provides the maintenance person with information on the image forming apparatus 100 and information on a remedial action that the user cannot perform. The maintenance person management system is an example of a predetermined notification destination. The predetermined notification destination may be, for example, an information terminal used by the maintenance person in charge of maintenance of the image forming apparatus 100.

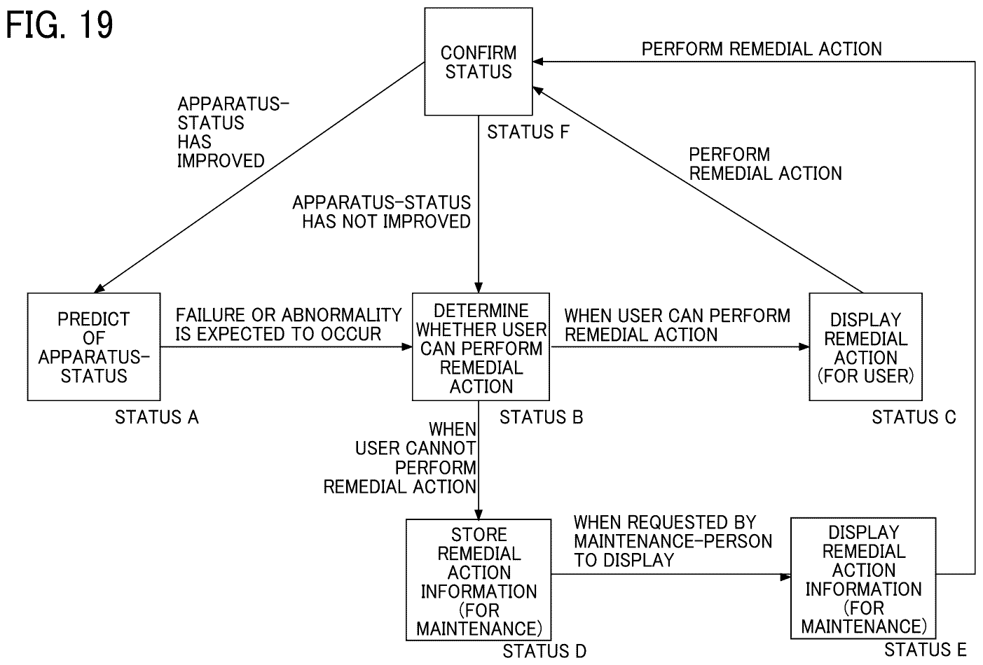

FIG. 19 is a diagram illustrating an example of status transition of the information providing system 1 according to the fourth embodiment. In the status A illustrated in FIG. 19, the information providing system 1 predicts the status of the apparatus (the image forming apparatus 100), and when the occurrence of a failure or an abnormality is predicted, the information providing system 1 transitions to the status B.

When the information providing system 1 transitions to the status B, the information providing system 1 determines whether the user can perform a remedial action to avoid a failure or an abnormality of the apparatus. When the user can perform the remedial action, the information providing system 1 transitions to the status C. On the other hand, when the user cannot perform the remedial action, the information providing system 1 transitions to the status D.

When the information providing system 1 transitions to the status C, the information providing system 1 displays the remedial action that the user can perform. When the user performs the remedial action, the information providing system 1 transitions to the status F.

When the information providing system 1 transitions to the status D, the information providing system 1 stores the remedial action that the user cannot perform. When a request to display the remedial action is received from the maintenance person, the information providing system 1 transitions to the status E.

When the information providing system 1 transitions to the status E, the information providing system 1 displays the remedial action that the user cannot perform. When the maintenance person performs the remedial action, the information providing system 1 transitions to the status F.

When the information providing system 1 transitions to the status F, the information providing system 1 checks the status of the apparatus (image forming apparatus 100). When the status of the apparatus is not improved, the information providing system 1 transitions to the status B.

On the other hand, when the status of the apparatus is improved, the information providing system 1 ends displaying the remedial action and transitions to the status A.

As described above, according to the fourth embodiment, when the user cannot perform the remedial action determined by the determination unit 505, the information providing system 1 arranges, for example, the maintenance person instead of displaying the remedial action.

### Functional Configuration of Information Providing System

In the above-described embodiments, the image forming apparatus 100 performs the process to be performed by the information providing system 1. However, at least a part of the process to be performed by the information providing system 1 may be performed by the server apparatus 202.

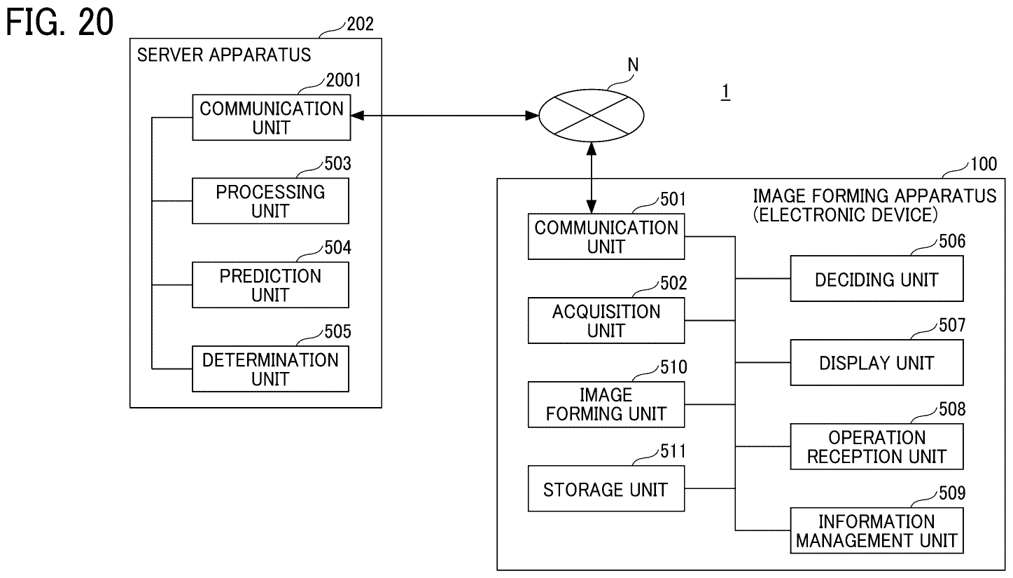

FIG. 20 is a block diagram illustrating another example of the system configuration of the information providing system 1 according to an embodiment.

In the example illustrated in FIG. 20, the server apparatus 202 includes the processing unit 503, the prediction unit 504, and the determination unit 505 among the functional configuration of the image forming apparatus 100 described with reference to FIG. 5. The server apparatus 202 further includes a communication unit 2001 that communicates with the image forming apparatus 100 via the communication network N.

In this case, the acquisition unit 502 of the image forming apparatus 100 acquires data for determining the status of the image forming apparatus 100, and transmits the acquired data to the server apparatus 202 via the communication unit 501. The acquisition unit 502 acquires the remedial action determined by the determination unit 505 from the server apparatus 202 via the communication unit 501.

On the other hand, the server apparatus 202 performs various processing including the data processing, the prediction processing, and the determination processing on the data received from the image forming apparatus 100, and transmits the determined remedial action to the image forming apparatus 100 via the communication unit 2001.

As described above, the information providing system 1 has various system configurations and functional configurations.

In the related art, when an image forming apparatus is in the predictive failure status, the magnitude of the failure risk of the image forming apparatus is determined and the determination result is notified. However, in the method according to the related art, since the determination result is information which prompts a user to arrange for a maintenance company, a failure may occur before the maintenance company arrives, and the downtime in which the image forming apparatus is not available may occur.

Such a problem is not limited to the image forming apparatus, and may commonly occur in various other electronic apparatuses.

According to an embodiment of the present disclosure, the occurrence of downtime due to a failure or an abnormality in an electronic apparatus is reduced.

As described above, according to each embodiment of the present disclosure, the occurrence of downtime due to a failure or an abnormality in an electronic apparatus is reduced.

Each of the functions of the above-described embodiments may be implemented by one or more processing circuits or circuitry. Processing circuitry includes a programmed processor, as a processor includes circuitry. A processing circuit also includes devices such as an application-specific integrated circuit (ASIC), a digital signal processor (DSP), a field programmable gate array (FPGA), and conventional circuit components arranged to perform the recited functions.

Some aspects of the present disclosure are described below.

The present specification discloses an information providing system, an electronic apparatus, an information providing method, and a program stored on a non-transitory recording medium.

### Aspect 1

According to Aspect 1, an information providing system includes an acquisition unit, a prediction unit, a determination unit, and a display unit. The acquisition unit acquires data for determining a status of an electronic apparatus.

The prediction unit predicts an occurrence of a failure or an abnormality of the electronic apparatus based on the data.

The determination unit determines a remedial action to be taken to avoid a failure or an abnormality of the electronic apparatus when the prediction unit predicts the occurrence of the failure or the abnormality.

The display unit displays the remedial action when the remedial action can be performed by a user.

### Aspect 2

According to Aspect 2, the information providing system of Aspect 1 further includes an information management unit. The information management unit stores the remedial action in a memory and manages the remedial action when the remedial action cannot be performed by a user.

### Aspect 3

According to Aspect 3, the information providing system further includes a data processing unit. The data processing unit processes the data acquired by the acquisition unit so that prediction accuracy by the prediction unit increases.

### Aspect 4

According to Aspect 4, in the information providing system of any one of Aspects 1 to 3, the display unit further displays different information based on a determination indicating whether the failure or the abnormality is improved after execution of the remedial action that the user can perform.

### Aspect 5

According to Aspect 5, in the information providing system of any one of Aspects 1 to 4, the display unit stops displaying the remedial action that the user can perform, when a predetermined time period has elapsed after the remedial action that the user can perform is displayed, or when the remedial action is performed more than a predetermined number of times.

### Aspect 6

According to Aspect 6, in the information providing system of any one of Aspects 1 to 5, the display unit displays detailed information on the remedial action to improve the failure or the abnormality in response to an operation by the user or a maintenance person.

The detailed information varies depending on whether the detailed information is for the user or the maintenance person.

### Aspect 7

According to Aspect 7, in the information providing system of any one of Aspects 1 to 6, the display unit is included in an information terminal different from the electronic apparatus includes the display unit.

### Aspect 8

According to Aspect 8, an electronic apparatus includes an acquisition unit, a prediction unit, a determination unit, and a display unit.

The acquisition unit acquires data for determining a status of an electronic apparatus.

The prediction unit predicts an occurrence of a failure or an abnormality of the electronic apparatus based on the data.

The determination unit determines a remedial action to be taken to avoid a failure or an abnormality of the electronic apparatus when the prediction unit predicts the occurrence of the failure or the abnormality.

The display unit displays the remedial action when the remedial action can be performed by a user.

### Aspect 9

According to Aspect 9, an information providing method performed by one or more processors includes acquiring data for determining a status of an electronic apparatus.

The information providing method includes predicting an occurrence of a failure or an abnormality of the electronic apparatus based on the data.

The information providing method includes determining a remedial action to be taken to avoid a failure or an abnormality of the electronic apparatus when the occurrence of the failure or the abnormality is predicted.

The information providing method includes displaying the remedial action on a display when the remedial action can be performed by a user.

### Aspect 10

A program which, when executed by one or more processors, causes the one or more processors to perform the information providing method according to Aspect 9.

The above-described embodiments and aspects are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

According to an embodiment of the present disclosure, the occurrence of downtime due to a failure or an abnormality in an electronic apparatus is reduced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An information providing system comprising:
circuitry configured to:
acquire data for determining a status of an electronic apparatus;
predict an occurrence of a failure or an abnormality of the electronic apparatus based on the data; and
determine a remedial action to be taken to avoid the failure or the abnormality of the electronic apparatus when the circuitry predicts the occurrence of the failure or the abnormality; and
a display to display the remedial action when the remedial action can be performed by a user.

2. The information providing system according to claim 1,
wherein the circuitry stores the remedial action in a memory when the remedial action cannot be performed by the user.

3. The information providing system according to claim 1,
wherein the circuitry processes the acquired data so that prediction accuracy by the circuitry increases.

4. The information providing system according to claim 1,
wherein the display further displays different information based on a determination indicating whether the failure or the abnormality is improved after execution of the remedial action.

5. The information providing system according to claim 1,
wherein the display stops displaying the remedial action, when a predetermined time period has elapsed after the remedial action is displayed, or when the remedial action is performed more than a predetermined number of times.

6. The information providing system according to claim 1,
wherein the display displays a detailed information on the remedial action in response to an operation by the user or a maintenance person, and
wherein the detailed information varies depending on whether the detailed information is for the user or for the maintenance person.

7. The information providing system according to claim 1,
wherein the display is included in an information terminal different from the electronic apparatus.

8. An electronic apparatus comprising:
circuitry configured to:
acquire data for determining a status of the electronic apparatus;
predict an occurrence of a failure or an abnormality of the electronic apparatus based on the data; and
determine a remedial action to be taken avoid the failure or the abnormality of the electronic apparatus when the circuitry predicts the occurrence of the failure or the abnormality of the electronic apparatus; and
a display to display the remedial action when the remedial action can be performed by a user.

9. An information providing method performed by one or more processors, the method comprising:
acquiring data for determining a status of an electronic apparatus;
predicting an occurrence of a failure or an abnormality of the electronic apparatus based on the data;
determining a remedial action to be taken to avoid the failure or the abnormality of the electronic apparatus when the occurrence of the failure or the abnormality of the electronic apparatus is predicted; and
displaying the remedial action on a display when the remedial action can be performed by a user.

10. A non-transitory recording medium storing a plurality of instructions which, when executed by one or more processors, causes the one or more processors to perform the information providing method according to claim 9.
